(19) United States
(12) Patent Application Publication
(10) Pub. No.: US 2026/0282159 A1
(43) Pub. Date: Sep. 17, 2026

(54) METHODS AND APPARATUSES FOR HANDLING PERIODIC CSI-RS OR TRANSMISSIONS UNDER CELL DTX/DRX

(71) Applicant: Telefonaktiebolaget LM Ericsson (publ), Stockholm (SE)

(72) Inventors: Sina MALEKI, Malmö (SE); Ajit NIMBALKER, Dublin, CA (US); Ravikiran NORY, San Jose, CA (US); Ali NADER, Malmö (SE); Rui FAN, Beijing (CN)

(21) Appl. No.: 19/471,294

(22) PCT Filed: Apr. 3, 2024
(86) PCT No.: PCT/SE2024/050300

§ 371 Date: Sep. 30, 2025

Related U.S. Application Data
(60) Provisional application No. 63/494,374, filed on Apr. 5, 2023.

(51) Int. Cl. H04W 76/28; H04L 27/26; H04W 52/02

(52) U.S. Cl. CPC H04W 76/28; H04L 27/261; H04W 52/0235

(57) ABSTRACT

A method, system and apparatus are disclosed. According to one aspect, a method in a network node configured to communicate with a wireless device (WD) and to manage reference signal transmissions during a discontinuous mode of operation is described. The method includes determining a configuration associated with the discontinuous mode of operation of the network node and the WD, where the discontinuous mode of operation includes an active period and an inactive period associated with a cell that corresponds to the network node. The method also includes transmitting one or more reference signals during the discontinuous mode of operation based on the configuration.

### TECHNICAL FIELD

The present disclosure relates to wireless communications, and in particular, to management of communication performed using discontinuous modes of operation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD) (e.g., user equipment (UE)), as well as communication between network nodes and between WDs. The 3GPP is also developing standards for Sixth Generation (6G) wireless communication networks.

In 3GPP Release 15 (Rel-15) NR, a WD can be configured with up to four carrier bandwidth parts (BWPs) in the downlink, where a single downlink carrier bandwidth part is active at a given time. A WD can be configured with up to four carrier bandwidth parts in the uplink, where a single uplink carrier bandwidth part is active at a given time. If a WD is configured with a supplementary uplink, the WD can additionally be configured with up to four carrier bandwidth parts in the supplementary uplink, where a single supplementary uplink carrier bandwidth part is active at a given time.

For a carrier bandwidth part with a given numerology, μᵢ, a contiguous set of physical resource blocks (PRBs) are defined and numbered from 0 to

$${N}_{BWP , i}^{s i z e} - 1 ,$$

where i is the index of the carrier bandwidth part. A resource block (RB) is defined as 12 consecutive subcarriers in the frequency domain.

Multiple orthogonal frequency-division multiplexing (OFDM) numerologies, μ, are supported in NR as given by Table 1, where the subcarrier spacing, Δf, and the cyclic prefix for a carrier bandwidth part are configured by different higher layer parameters for downlink (DL) and uplink (UL), respectively.

TABLE 1
Supported transmission numerologies.

| μ | Δf = 2^{μ} · 15 [kHz] | Cyclic prefix |
|---|---|---|
| 0 | 15 | Normal |
| 1 | 30 | Normal |
| 2 | 60 | Normal, |
| | | Extended |
| 3 | 120 | Normal |
| 4 | 240 | Normal |

### Physical Channels

A downlink physical channel may correspond to a set of resource elements carrying information originating from higher layers. The following are examples of defined downlink physical channels:
Physical Downlink Shared Channel (PDSCH);
Physical Broadcast Channel (PBCH); and
Physical Downlink Control Channel (PDCCH).

PDSCH may be the main physical channel used for unicast downlink data transmission, but also for transmission of random access response (RAR), certain system information blocks, and paging information. PBCH may carry basic system information, e.g., required by the WD to access the network. PDCCH may be used for transmitting downlink control information (DCI), mainly scheduling decisions, e.g., required for reception of PDSCH, and for uplink scheduling grants enabling transmission on PUSCH.

An uplink physical channel may correspond to a set of resource elements carrying information originating from higher layers. The following uplink physical channels may be defined:
Physical Uplink Shared Channel (PUSCH);
Physical Uplink Control Channel (PUCCH); and
Physical Random Access Channel (PRACH).

PUSCH is the uplink counterpart to the PDSCH. PUCCH is used by WDs to transmit uplink control information, including hybrid automatic repeat request (HARQ) acknowledgements, channel state information reports, etc. PRACH is used for random access preamble transmission.

### NR Reference Symbols

Ultra-lean design principles in NR aim to minimize the always-on transmissions that exists in earlier systems (e.g., LTE CRS reference symbols). Instead, NR provides reference symbols such as SS blocks (SSBs) on a periodic basis, by default once every 20 ms. In addition, for connected mode WDs, typically a set of reference symbols are provided for optimal link performance. Some of these reference symbols are clarified below.

### Channel State Information Reference Signal (CSI-RS) for Tracking

A WD in radio resource control (RRC) connected mode is expected to receive from the network the RRC layer WD specific configuration of a non-zero power channel state information resource set (NZP-CSI-RS-ResourceSet) configured including the parameter trs-Info. For an NZP-CSI-RS-ResourceSet configured with the higher layer parameter trs-Info set to “true”, the WD may assume the antenna port with the same port index of the configured NZP CSI-RS resources in the NZP-CSI-RS-ResourceSet is the same.
For frequency range 1 (FR1), the WD may be configured with one or more NZP CSI-RS set(s), where an NZP-CSI-RS-ResourceSet consists of four periodic NZP CSI-RS resources in two consecutive slots with two periodic NZP CSI-RS resources in each slot. If no two consecutive slots are indicated as downlink slots by tdd-UL-DL-ConfigurationCommon or tdd-UL-DL-ConfigDedicated, then the WD may be configured with one or more NZP CSI-RS set(s), where an NZP-CSI-RS-ResourceSet consists of two periodic NZP CSI-RS resources in one slot.
For frequency range 2 (FR2), the WD may be configured with one or more NZP CSI-RS set(s), where a NZP-CSI-RS-ResourceSet consists of two periodic CSI-RS resources in one slot or with a NZP-CSI-RS-ResourceSet of four periodic NZP CSI-RS resources in two consecutive slots with two periodic NZP CSI-RS resources in each slot.

A WD configured with NZP-CSI-RS-ResourceSet(s) configured with higher layer parameter trs-Info may have the CSI-RS resources configured as:
Periodic, with the CSI-RS resources in the NZP-CSI-RS-ResourceSet configured with same periodicity, bandwidth and subcarrier location
Periodic CSI-RS resource in one set and aperiodic CSI-RS resources in a second set, with the aperiodic CSI-RS and periodic CSI-RS resource having the same bandwidth (with same resource block (RB) location) and the aperiodic CSI-RS being ‘QCL-Type-A’ and ‘QCL-TypeD’, where applicable, with the periodic CSI reference signal (CSI-RS) resources. For frequency range 2, the WD does not expect that the scheduling offset between the last symbol of the PDCCH carrying the triggering DCI and the first symbol of the aperiodic CSI-RS resources is smaller than the WD reported ThresholdSched-Offset. The WD may expect that the periodic CSI-RS resource set and aperiodic CSI-RS resource set are configured with the same number of CSI-RS resources and with the same number of CSI-RS resources in a slot. For the aperiodic CSI-RS resource set if triggered, and if the associated periodic CSI-RS resource set is configured with four periodic CSI-RS resources with two consecutive slots with two periodic CSI-RS resources in each slot, the higher layer parameter aperiodicTriggeringOffset indicates the triggering offset for the first slot for the first two CSI-RS resources in the set.

In some cases, a WD does not expect to be configured with a CSI-ReportConfig that is linked to a CSI-ResourceConfig including an NZP-CSI-RS-ResourceSet configured with trs-Info and with the CSI-ReportConfig configured with the higher layer parameter time RestrictionForChannelMeasurements set to ‘configured’.

Further, a WD may not expect to be configured with a CSI-ReportConfig with the higher layer parameter reportQuantity set to other than ‘none’ for aperiodic NZP CSI-RS resource set configured with trs-Info. A WD does not expect to be configured with a CSI-ReportConfig for periodic NZP CSI-RS resource set configured with trs-Info. A WD does not expect to be configured with an NZP-CSI-RS-ResourceSet configured both with trs-Info and repetition.

Each CSI-RS resource, e.g., defined in clause 7.4.1.5.3 of 3GPP Technical Specification (TS) 38.211 V18.0.0 (hereinafter referred to as “3GPP TS 38.211”), is configured by the higher layer parameter NZP-CSI-RS-Resource with the following restrictions:
the time-domain locations of the two CSI-RS resources in a slot, or of the four CSI-RS resources in two consecutive slots (which are the same across two consecutive slots), as defined by higher layer parameter CSI-RS-resourceMapping, is given by one of:
l∈{4,8}, l∈{5,9}, or l∈{6,10} for frequency range 1 and frequency range 2,
l∈{0,4}, l∈{1,5}, l∈{2,6}, l∈{3,7}, l∈{7,11}, l∈{8,12} or l∈{9,13} for frequency range 2.
a single port CSI-RS resource with density ρ=3 given by Table 7.4.1.5.3-1 from 3GPP TS 38.211 and higher layer parameter density configured by CSI-RS-ResourceMapping.
the bandwidth of the CSI-RS resource, as given by the higher layer parameter freqBand configured by CSI-RS-ResourceMapping, is the minimum of 52 and

$${N}_{BWP , i}^{s i z e}$$

resource blocks, or is equal to

$${N}_{BWP , i}^{s i z e}$$

resource blocks. For operation with shared spectrum channel access, freqBand configured by CSI-RS-ResourceMapping, is the minimum of 48 and

$${N}_{BWP , i}^{s i z e}$$

resource blocks, or is equal to

$${N}_{BWP , i}^{s i z e}$$

resource blocks.
the WD is not expected to be configured with the periodicity of 2^{μ}×10 slots if the bandwidth of CSI-RS resource is larger than 52 resource blocks.
the periodicity and slot offset for periodic NZP CSI-RS resources, as given by the higher layer parameter periodicityAndOffset configured by NZP-CSI-RS-Resource, is one of 2^{μ}Xₚ slots where Xₚ=10, 20, 40, or 80 and where μ is defined in 3GPP TS 38.211, clause 4.3.
same powerControlOffset and powerControlOffsetSS given by NZP-CSI-RS-Resource value across all resources.

### NZP CSI-RS

The WD can be configured with one or more NZP CSI-RS resource set configuration(s) as indicated by the higher layer parameters CSI-ResourceConfig, and NZP-CSI-RS-ResourceSet. Each NZP CSI-RS resource set consists of K≥1 NZP CSI-RS resource(s).

The following parameters, for which the WD may assume non-zero transmission power for CSI-RS resource, are configured via the higher layer parameter NZP-CSI-RS-Resource, CSI-ResourceConfig and NZP-CSI-RS-ResourceSet for each CSI-RS resource configuration:
nzp-CSI-RS-ResourceId determines CSI-RS resource configuration identity.
periodicityAndOffset defines the CSI-RS periodicity and slot offset for periodic/semi-persistent CSI-RS. All the CSI-RS resources within one set are configured with the same periodicity, while the slot offset can be same or different for different CSI-RS resources.
resourceMapping defines the number of ports, code division multiplex (CDM)-type, and orthogonal frequency division multiplex (OFDM) symbol and subcarrier occupancy of the CSI-RS resource within a slot that are given in 3GPP TS 38.211, clause 7.4.1.5.
nrofPorts in resourceMapping defines the number of CSI-RS ports, where the allowable values are given in 3GPP TS 38.211, clause 7.4.1.5.
density in resourceMapping defines CSI-RS frequency density of each CSI-RS port per PRB, and CSI-RS PRB offset in case of the density value of ½, where the allowable values are given in 3GPP TS 38.211, clause 7.4.1.5 of. For density ½, the odd/even physical resource block (PRB) allocation indicated in density is with respect to the common resource block grid.
cdm-Type in resourceMapping defines CDM values and pattern, where the allowable values are given in 3GPP TS 38.211, clause 7.4.1.5.
powerControlOffset: which is the assumed ratio of PDSCH EPRE to NZP CSI-RS emitted power per resource element (EPRE) when the WD derives CSI feedback and takes values in the range of [−8, 15] dB with 1 dB step size.
powerControlOffsetSS: which is the assumed ratio of NZP CSI-RS EPRE to SS/PBCH block EPRE.
scramblingID defines scrambling ID of CSI-RS with length of 10 bits.
BWP-Id in CSI-ResourceConfig defines which bandwidth part the configured CSI-RS is located in.
repetition in NZP-CSI-RS-ResourceSet is associated with a CSI-RS resource set and defines whether the WD can assume the CSI-RS resources within the NZP CSI-RS Resource Set are transmitted with the same downlink spatial domain transmission filter or not as described in Clause 5.1.6.1.2, and can be configured only when the higher layer parameter reportQuantity associated with all the reporting settings linked with the CSI-RS resource set is set to ‘cri-RSRP’, ‘cri-SINR’ or ‘none’.
qcl-InfoPeriodicCSI-RS contains a reference to a TCI-State indicating quasi-colocation (QCL) source RS(s) and QCL type(s). If the TCI-State is configured with a reference to an RS with ‘QCL-TypeD’ association, that RS may be a synchronization signal (SS)/PBCH block located in the same or different CC/DL BWP, or a CSI-RS resource configured as periodic located in the same or different CC/DL BWP.
trs-Info in NZP-CSI-RS-ResourceSet is associated with a CSI-RS resource set and for which the WD can assume that the antenna port with the same port index of the configured NZP CSI-RS resources in the NZP-CSI-RS-ResourceSet is the same as described in Clause 5.1.6.1.1 and can be configured when reporting setting is not configured or when the higher layer parameter reportQuantity associated with all the reporting settings linked with the CSI-RS resource set is set to ‘none’.

All CSI-RS resources within one set are configured with same density and same nrofPorts, except for the NZP CSI-RS resources used for interference measurement.

The WD expects that all the CSI-RS resources of a resource set are configured with the same starting RB and number of RBs and the same cdm-type.

The bandwidth and initial common resource block (CRB) index of a CSI-RS resource within a BWP, as defined in 3GPP TS 38.211, clause 7.4.1.5, are determined based on the higher layer parameters nrofRBs and startingRB, respectively, within the CSI-FrequencyOccupation information element (IE) configured by the higher layer parameter freqBand within the CSI-RS-ResourceMapping IE. Both nrofRBs and startingRB are configured as integer multiples of 4 RBs, and the reference point for startingRB is CRB 0 on the common resource block grid. If

$$startingRB < {N}_{BWP}^{start} ,$$

the WD may assume that the initial CRB index of the CSI-RS resource is

$${N}_{initial RB} = {N}_{BWP}^{start} ,$$

otherwise N_{initial RB}=startingRB. If

$$nrofRBs > {N}_{BWP}^{s i z e} + {N}_{BWP}^{start} - {N}_{initial RB} ,$$

the UE shall assume that the bandwidth of the CSI-RS resource is

$${N}_{CSI - RS}^{BW} = {N}_{BWP}^{s i z e} + {N}_{BWP}^{start} - {N}_{initial RB} ,$$

otherwise

$${N}_{CSI - RS}^{BW} = nrofRBs .$$

In an cases, the UE shall expect that

$${N}_{CSI - RS}^{BW} \geq min ( 24 , {N}_{BWP}^{s i z e} ) .$$

### Network Power Consumption

Energy consumption is a considerable challenge for 5G systems today where a major contributor to the energy consumption is the radio unit of radio access network (RAN) system. The network power consumption for NR is said to be less compared to LTE because of its lean design, i.e., no CRS and the SSB periodicity is by default 20 ms. However, NR in the current implementation might consume more energy compared to LTE, partly due to higher BWs, shorter TTIs and massive number of antennas. This is still evident even at times when cells and beams are lightly loaded or serve no traffic or no users at all. In order to enable an energy efficient network, 3GPP initiated a 3GPP release 18 (Rel-18) study item (SI) on network energy savings in NR, which was concluded with the outcome captured in 3GPP TR 38.864. Following the SI phase, a new work item (WI) on network energy savings in NR was approved, and the following objectives were specified:
1. Specify SSB-less SCell operation for inter-band carrier aggregation (CA) for FR1 and co-located cells, if found feasible by RAN4 study, where a WD measures SSB transmitted on primary cell (PCell) or another secondary cell (SCell) for SCell time/frequency synchronization (including downlink AGC), and L1/L3 measurements, including potential enhancement on SCell activation procedures if necessary [RAN4, RAN2].
2. Specify enhancement on cell discontinuous transmission (DTX) and/or discontinuous reception (DRX) mechanism including the alignment of cell DTX/DRX and WD DRX in RRC_CONNECTED mode, and inter-node information exchange on cell DTX/DRX [RAN2, RAN1, RAN3].
   Note: No change for SSB transmission due to cell DTX/DRX.
   Note: The impact on IDLE/INACTIVE WDs due to the above enhancement should be avoided.
3. Specify the following techniques in spatial and power domains:
   Specify necessary enhancements on CSI and beam management related procedures including measurement and report, and signaling to enable efficient adaptation of spatial elements (e.g. antenna ports, active transceiver chains) [RAN1, RAN2].
   Specify necessary enhancements on CSI related procedures including measurement and report, and signaling to enable efficient adaptation of power offset values between PDSCH and CSI-RS [RAN1, RAN2].
   Note: Above objectives are only for WD specific channels/signals.
   Note: Legacy WD CSI/CSI-RS capabilities applies when considering total number of CSI reports and requirements.
4. Specify mechanism(s) to prevent legacy WDs camping on cells adopting the Rel-18 NES techniques, if necessary [RAN2].

During cell DTX/DRX inactive time, a WD may not expect to receive some signals/channels or being able to transmit some signals/channels. Among them, periodic CSI-RS and particularly CSI-RS for tracking or tracking reference signal (TRS) is considered as one of the candidates that the WD may not expect them to be transmitted during the inactive time of cell DTX/DRX. While this leads to saving energy at the network side, it can impact WD reception performance, e.g., to receive PDCCH/PDSCH. There is thus a need for mechanisms to reduce the impact on WD reception performance.

### SUMMARY

Some embodiments advantageously provide methods, systems, and apparatuses for handling periodic reference signal ((e.g., CSI-RS, TRS, etc.) transmissions under a cell discontinuous mode of operation (e.g., DTX/DRX).

In some embodiments, a WD obtains information about selective CSI-RS (including, particularly CSI-RS for tracking signals) transmissions during inactive time of cell DTX/DRX.

In some other embodiments, one or more steps are performed and are associated with enhancement of cell discontinuous transmission/reception processes including the alignment of cell discontinuous transmission/reception (e.g., DTX/DRX and WD DRX in RRC_CONNECTED mode, and inter-node information exchange on cell DTX/DRX). In some embodiments, one or more time domain techniques are used for achieving energy savings at the network side.

In some other embodiments, discontinuous transmission (DTX) and discontinuous reception (DRX) at the network side is described (e.g., within the 3GPP Rel-18 network energy saving work item for the purpose of network energy savings on downlink (DL) and uplink (UL), respectively).

In some embodiments, with respect to cell DTX, sleeping/OFF occasions may be used during which the serving cell may go to a sleep state on DL (e.g., sleeping occasions during which the cell reduces or completely may stop all/some transmissions). With respect to cell DRX, sleeping/OFF occasions may be used during which the serving cell may go to a sleep state on UL (e.g., sleeping occasions during which the cell reduces or completely may stop all/some receptions).

In some other embodiments, the network node may reduce transmission of periodic CSI-RS (and particularly TRS transmissions) during inactive time of cell DTX/DRX, thereby saving energy. Further, WD decoding performance may be improved (e.g. compared to the case when no CSI-RS transmissions are allowed during inactive time of cell DTX/DRX) by allowing the WD to selectively receive CSI-RS during inactive time of cell DTX/DRX (e.g. before PDCCH/PDSCH transmissions).

According to one aspect, a network node configured to communicate with a wireless device (WD) is described. The network node is configured to and/or includes a radio interface and/or processing circuitry configured to determine a configuration associated with communication between the network node and the WD during a discontinuous mode of operation, where the discontinuous mode of operation is associated with an inactive period associated with a cell and transmit signaling during the discontinuous mode of operation based on the configuration.

According to another aspect, a method implemented in a network node configured to communicate with a wireless device (WD) is described. The method includes determining a configuration associated with communication between the network node and the WD during a discontinuous mode of operation, where the discontinuous mode of operation is associated with an inactive period associated with a cell and transmitting signaling during the discontinuous mode of operation based on the configuration.

According to one aspect, a wireless device (WD) configured to communicate with a network node is described. The WD is configured to, and/or includes a radio interface and/or processing circuitry configured to determine a configuration associated with communication between the network node and the WD during a discontinuous mode of operation, where the discontinuous mode of operation is associated with an inactive period associated with a cell and receive signaling during the discontinuous mode of operation based on the configuration.

According to another aspect, a method in a wireless device (WD) configured to communicate with a network node is described. The method comprises determining a configuration associated with communication between the network node and the WD during a discontinuous mode of operation, where the discontinuous mode of operation is associated with an inactive period associated with a cell and receiving signaling during the discontinuous mode of operation based on the configuration.

According to one aspect, a method in a network node configured to communicate with a wireless device (WD) and to manage reference signal transmissions during a discontinuous mode of operation is described. The method includes determining a configuration associated with the discontinuous mode of operation of the network node and the WD, where the discontinuous mode of operation includes an active period and an inactive period associated with a cell that corresponds to the network node. The method also includes transmitting one or more reference signals during the discontinuous mode of operation based on the configuration.

In some embodiments, one or both of: (A) the configuration includes a first indication indicating that at least one reference signal of the one or more reference signals that is to be transmitted during the active period has a first periodicity and at least one other reference signal of the one or more reference signals that is to be transmitted during the inactive period has a second periodicity, where the second periodicity is lower than the first periodicity; and (B) the method further includes transmitting the at least one reference signal with the first periodicity and the at least one other reference signal with the second periodicity.

In some other embodiments, the configuration includes a second indication preventing the network node to transmit any reference signal of the one or more reference signals during the inactive period.

In some embodiments, the configuration includes a third indication indicating a time location for at least one of the one or more reference signals. The time location is based on a wakeup period of the WD.

In some other embodiments, the time location is within a time window, and the time window has at least one portion that overlaps with the wakeup period of the WD.

In some embodiments, the time location within the time window is prior in time to the wakeup period of the WD.

In some other embodiments, the method further includes transmitting at least one of the one or more reference signals at a time that corresponds to the time location.

In some embodiments, the at least one of the one or more reference signals is usable by the WD to perform a corresponding action before the wakeup period begins and before the WD one or both of receives and transmits data during the wakeup period.

In some other embodiments, the configuration further includes a fourth indication indicating that if a wakeup signal is to be transmitted to the WD. The wakeup signal includes a notification of an upcoming on duration period within the active period and a reference signal available for the WD associated with upcoming data.

In some embodiments, one or both of: (A) the configuration further includes a condition that if signaling is received from the WD, the received signal is to trigger the network node to transmit at least one of the one or more reference signals; and (B) the method further includes receiving the signaling from the WD and in response to receiving the signaling, transmitting the at least one of the one or more reference signals to the WD.

In some other embodiments, the method further includes transmitting the configuration to the WD.

In some embodiments, the one or more reference signals include one or both of a channel state information reference signal (CSI-RS), and a tracking reference signal (TRS).

According to another aspect, a network node configured to communicate with a wireless device (WD) and to manage reference signal transmissions during a discontinuous mode of operation is described. The network node is configured to determine a configuration associated with the discontinuous mode of operation of the network node and the WD, where the discontinuous mode of operation includes an active period and an inactive period associated with a cell that corresponds to the network node. The network node is also configured to transmit one or more reference signals during the discontinuous mode of operation based on the configuration.

In some embodiments, one or both of: (A) the configuration includes a first indication indicating that at least one reference signal of the one or more reference signals that is to be transmitted during the active period has a first periodicity and at least one other reference signal of the one or more reference signals that is to be transmitted during the inactive period has a second periodicity, where the second periodicity is lower than the first periodicity; and (B) the network node is further configured to transmit the at least one reference signal with the first periodicity and the at least one other reference signal with the second periodicity.

In some other embodiments, the configuration includes a second indication preventing the network node from transmitting any reference signal of the one or more reference signals during the inactive period.

In some embodiments, the configuration includes a third indication indicating a time location for at least one of the one or more reference signals. The time location is based on a wakeup period of the WD.

In some other embodiments, the time location is within a time window, the time window having at least one portion that overlaps with the wakeup period of the WD.

In some embodiments, the time location within the time window is prior in time to the wakeup period of the WD.

In some other embodiments, the network node is further configured to transmit at least one of the one or more reference signals at a time that corresponds to the time location.

In some embodiments, the at least one of the one or more reference signals is usable by the WD to perform a corresponding action before the wakeup period begins and before the WD one or both of receives and transmits data during the wakeup period.

In some other embodiments, the configuration further includes a fourth indication indicating that if a wakeup signal is to be transmitted to the WD, the wakeup signal includes a notification of an upcoming on duration period within the active period and a reference signal available for the WD associated with upcoming data.

In some embodiments, one or both of (A) the configuration further includes a condition that if signaling is received from the WD, the received signal is to trigger the network node to transmit at least one of the one or more reference signals; and (B) the network node is further configured to receive the signaling from the WD and in response to receiving the signaling, transmit the at least one of the one or more reference signals to the WD.

In some other embodiments, the network node is further configured to transmit the configuration to the WD.

In some embodiments, the one or more reference signals include one or both of a channel state information reference signal (CSI-RS) and a tracking reference signal (TRS).

According to one aspect, a method in a wireless device (WD) configured to communicate with a network node configured to manage reference signal transmissions during a discontinuous mode of operation is described. The method includes receiving a configuration associated with the discontinuous mode of operation of the network node and the WD, where the discontinuous mode of operation includes an active period and an inactive period associated with a cell that corresponds to the network node. The method also includes receiving one or more reference signals during the discontinuous mode of operation based on the configuration.

In some embodiments, one or both of: (A) the configuration includes a first indication indicating that at least one reference signal of the one or more reference signals that is to be transmitted during the active period has a first periodicity and at least one other reference signal of the one or more reference signals that is to be transmitted during the inactive period has a second periodicity, where the second periodicity is lower than the first periodicity; and (B) the method further includes receiving the at least one reference signal with the first periodicity and the at least one other reference signal with the second periodicity.

In some other embodiments, the configuration includes a second indication preventing the network node from transmitting any reference signal of the one or more reference signals during the inactive period.

In some embodiments, one or more of: (A) the configuration includes a third indication indicating a time location for at least one of the one or more reference signals, where the time location is based on a wakeup period of the WD; (B) the time location is within a time window, where the time window has at least one portion that overlaps with the wakeup period of the WD; (C) the time location within the time window is prior in time to the wakeup period of the WD; and (D) the method further includes transmitting at least one of the one or more reference signals at a time that corresponds to the time location.

In some other embodiments, the at least one of the one or more reference signals is usable by the WD to perform a corresponding action before the wakeup period begins and before the WD one or both of receives and transmits data during the wakeup period.

In some embodiments, the configuration further includes a fourth indication indicating that if a wakeup signal is to be transmitted to the WD, and the wakeup signal includes a notification of an upcoming on duration period within the active period and a reference signal available for the WD associated with upcoming data.

According to another aspect, a wireless device (WD) configured to communicate with a network node configured to manage reference signal transmissions during a discontinuous mode of operation is described. The WD is configured to receive a configuration associated with the discontinuous mode of operation of the network node and the WD, where the discontinuous mode of operation comprising an active period and an inactive period associated with a cell that corresponds to the network node. The WD is also configured to receive one or more reference signals during the discontinuous mode of operation based on the configuration.

In some embodiments, one or both of: (A) the configuration includes a first indication indicating that at least one reference signal of the one or more reference signals that is to be transmitted during the active period has a first periodicity and at least one other reference signal of the one or more reference signals that is to be transmitted during the inactive period has a second periodicity, where the second periodicity is lower than the first periodicity; and (B) the method further includes receiving the at least one reference signal with the first periodicity and the at least one other reference signal with the second periodicity.

In some other embodiments, the configuration includes a second indication preventing the network node from transmitting any reference signal of the one or more reference signals during the inactive period.

In some embodiments, one or more of: (A) the configuration includes a third indication indicating a time location for at least one of the one or more reference signals, where the time location is based on a wakeup period of the WD; (B) the time location is within a time window, the time window having at least one portion that overlaps with the wakeup period of the WD; (C) the time location within the time window is prior in time to the wakeup period of the WD; and (D) the WD is further configured to transmit at least one of the one or more reference signals at a time that corresponds to the time location.

In some other embodiments, the at least one of the one or more reference signals is usable by the WD to perform a corresponding action before the wakeup period begins and before the WD one or both of receives and transmits data during the wakeup period.

In some embodiments, the configuration further includes a fourth indication indicating that if a wakeup signal is to be transmitted to the WD, the wakeup signal includes a notification of an upcoming on duration period within the active period and a reference signal available for the WD associated with upcoming data.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node according to some embodiments of the present disclosure;

FIG. 8 is a flowchart of an exemplary process in a wireless device according to some embodiments of the present disclosure;

FIG. 9 is a flowchart of an exemplary process in a network node according to some embodiments of the present disclosure;

FIG. 10 is a flowchart of an exemplary process in a wireless device according to some embodiments of the present disclosure;

FIG. 11 shows example elements of communication between a network node according to some embodiments of the present disclosure; and

FIG. 12 shows example elements of communication between a network node and a WD at least during a discontinuous mode of operation according to some embodiments of the present disclosure;

FIG. 13 shows other example elements of communication between a network node and a WD at least during a discontinuous mode of operation according to some embodiments of the present disclosure;

FIG. 14 shows other example elements of communication between a network node and a WD at least during a discontinuous mode of operation according to some embodiments of the present disclosure; and

FIG. 15 shows other example elements of communication between a network node and a WD at least during a discontinuous mode of operation according to some embodiments of the present disclosure.

### DETAILED DESCRIPTION

Before describing in detail exemplary embodiments, it is noted that the embodiments reside primarily in combinations of apparatus components and processing steps related to handling periodic CSI-RS transmissions under cell DTX/DRX. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

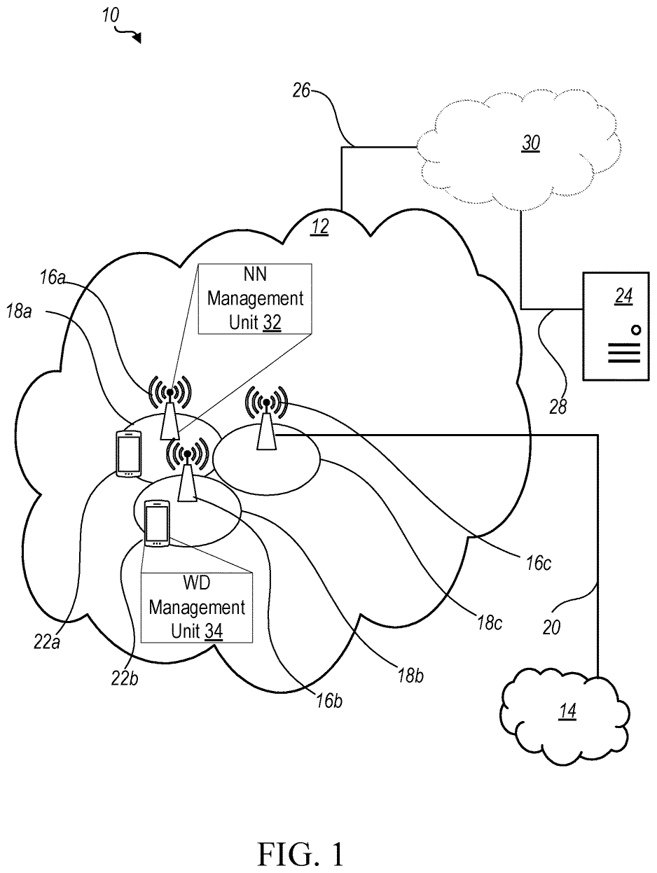

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). A coverage area 18 may be referred to as a cell 18 established by a network node 16. Thus, a cell forms a coverage area 18. As such, cell 18 is used interchangeably herein with coverage area 18. Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured to perform any step and/or task and/or process and/or method and/or feature described in the present disclosure, e.g., associated with a NN function. A wireless device 22 is configured to include a WD management unit 34 which is configured to perform any step and/or task and/or process and/or method and/or feature described in the present disclosure, e.g., associated with a WD function.

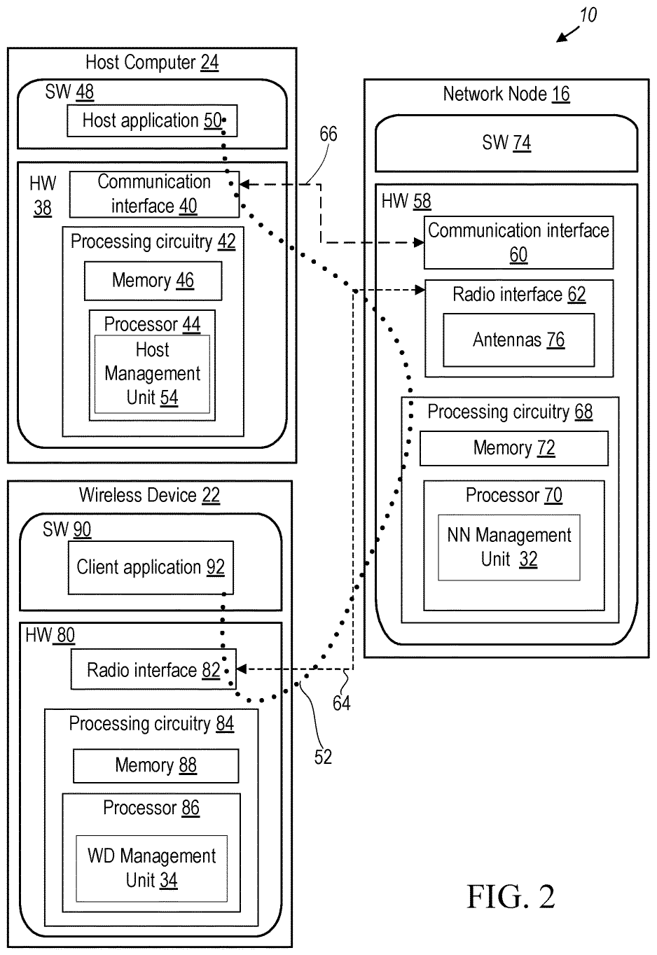

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host management unit 54 configured to enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a NN management unit 32 which is configured to perform any step and/or task and/or process and/or method and/or feature described in the present disclosure, e.g., associated with a NN function.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 which is configured to perform any step and/or task and/or process and/or method and/or feature described in the present disclosure, e.g., associated with a WD function.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as NN management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

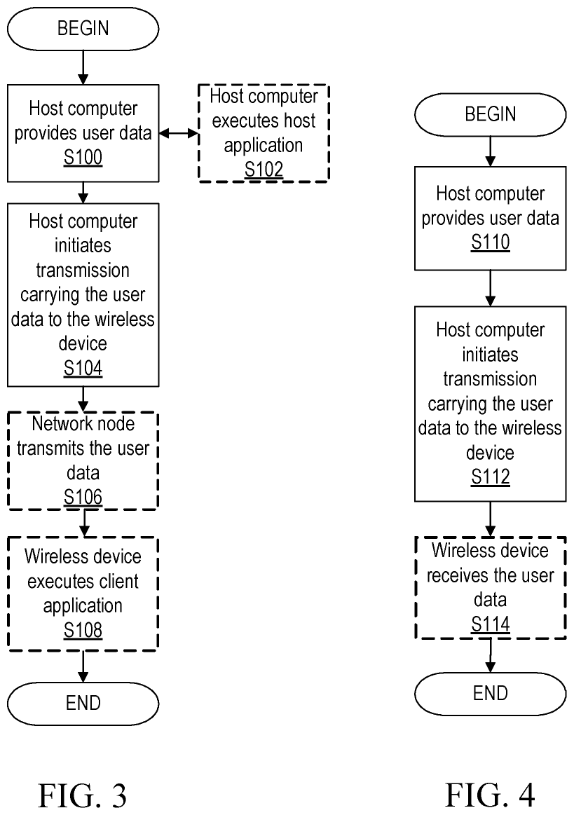

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

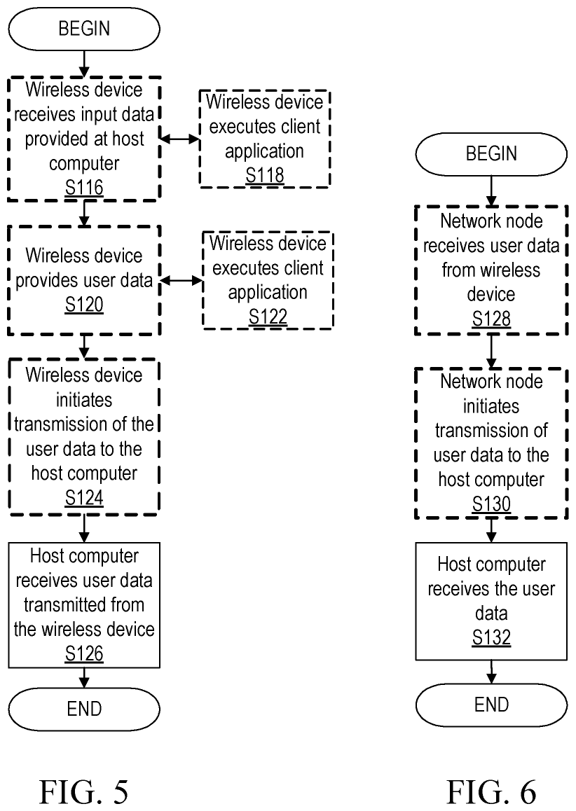

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

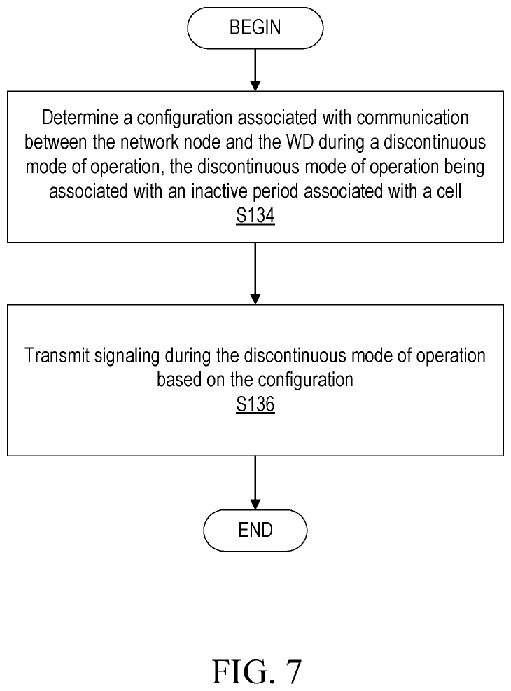

FIG. 7 is a flowchart of an exemplary process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to determine (Block S134) a configuration associated with communication between the network node 16 and the WD 22 during a discontinuous mode of operation, where the discontinuous mode of operation is associated with an inactive period associated with a cell, and transmit (Block S136) signaling during the discontinuous mode of operation based on the configuration.

In some embodiments, the method further comprises transmitting a first scheduling physical downlink control channel (PDCCH) during the inactive period of the discontinuous mode of operation and transmitting a tracking reference signal (TRS) after the first scheduling PDCCH and after the WD 22 receives a first physical downlink shared channel (PDSCH).

In some other embodiments, one or more of: the method further comprises transmitting the configuration to the WD 22, where the configuration comprises an indication of potential TRS transmissions for the inactive period of cell discontinuous transmission and/or reception; the configuration indicates a window of a specific length and periodicity within which the WD 22 can expect a TRS transmission; and the configuration triggers the WD 22 to monitor TRS during a first TRS occasion or TRS window and/or to receive a first scheduling PDCCH and a first PDSCH if a TRS is detected.

In some embodiments, the method comprises one or more of: transmitting a TRS configuration comprising at least a first periodicity and offset, where the TRS configuration triggers the WD 22 to, during an active time of cell discontinuous transmission and/or reception, assume that TRS is present in TRS occasions indicated by the TRS configuration according to the first periodicity and offset; determining a cell discontinuous transmission configuration indicating that the WD 22 does not need to monitor PDCCH in downlink during a time the network node is in a cell discontinuous transmission inactive period; stopping a TRS transmission or cause the WD to not expect the TRS transmission during cell discontinuous transmission and/or reception inactive periods, unless there is an uplink transmission from the WD 22 or there is a predetermined type of uplink transmission from the WD 22; and causing first and second TRS transmissions in a cell discontinuous transmission and/or reception active period according to first and second TRS configuration sets, respectively.

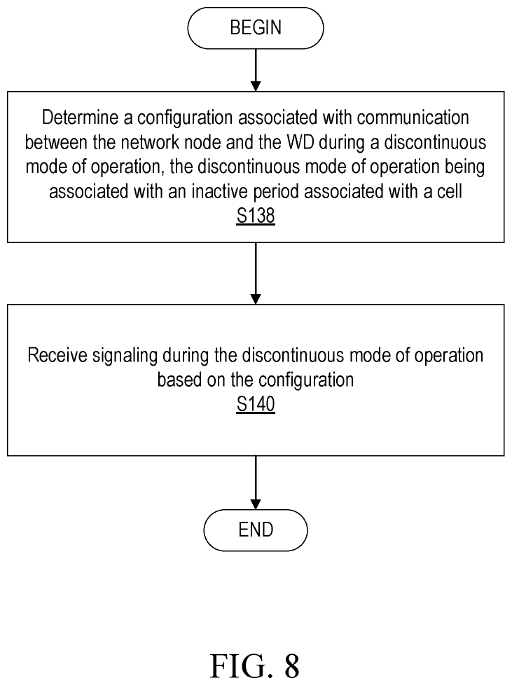

FIG. 8 is a flowchart of an exemplary process in a wireless device 22. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to determine (Block S138) a configuration associated with communication between the network node and the WD 22 during a discontinuous mode of operation, where the discontinuous mode of operation is associated with an inactive period associated with a cell, and receive (Block S140) signaling during the discontinuous mode of operation based on the configuration.

In some embodiments, the method further comprises receiving a first scheduling physical downlink control channel (PDCCH) during the inactive period of the discontinuous mode of operation and receiving a tracking reference signal (TRS) after the first scheduling PDCCH and after the WD 22 receives a first physical downlink shared channel (PDSCH).

In some other embodiments one or more of: the method further comprises receiving the configuration from the network node, where the configuration comprises an indication of potential TRS transmissions for the inactive period of cell discontinuous transmission and/or reception; the configuration indicates a window of a specific length and periodicity within which the WD 22 can expect a TRS transmission; and the configuration triggers the WD 22 to monitor TRS during a first TRS occasion or TRS window and/or to receive a first scheduling PDCCH and a first PDSCH if a TRS is detected.

In some embodiments, the method further comprises one or more of: receiving a TRS configuration comprising at least a first periodicity and offset, where the TRS configuration triggers the WD 22 to, during an active time of cell discontinuous transmission and/or reception, assume that TRS is present in TRS occasions indicated by the TRS configuration according to the first periodicity and offset; determining a cell discontinuous transmission configuration indicating that the WD does not need to monitor PDCCH in downlink during a time the network node is in a cell discontinuous transmission inactive period; determining that the TRS transmission is not expected during cell discontinuous transmission and/or reception inactive periods, unless there is an uplink transmission from the WD 22 or there is a predetermined type of uplink transmission from the WD 22; and receiving first and second TRS transmissions in a cell discontinuous transmission and/or reception active period according to first and second TRS configuration sets, respectively.

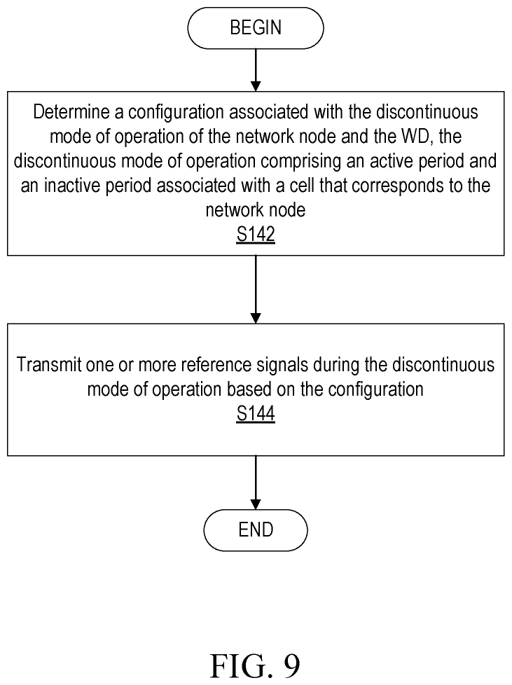

FIG. 9 is a flowchart of an exemplary process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to communicate with a WD 22 and to manage reference signal transmissions during a discontinuous mode of operation. Network node 16 is configured to determine (Block S142) a configuration associated with the discontinuous mode of operation of the network node 16 and the WD 22, where the discontinuous mode of operation includes an active period 102 and an inactive period 104 associated with a cell 18 that corresponds to the network node 16. The network node 16 is also configured to transmit (Block S144) one or more reference signals 106 during the discontinuous mode of operation based on the configuration.

In some embodiments, one or both of: (A) the configuration includes a first indication indicating that at least one reference signal 106 of the one or more reference signals 106 that is to be transmitted during the active period 102 has a first periodicity and at least one other reference signal 106 of the one or more reference signals 106 that is to be transmitted during the inactive period 104 has a second periodicity, where the second periodicity is lower than the first periodicity; and (B) the method further includes transmitting the at least one reference signal 106 with the first periodicity and the at least one other reference signal 106 with the second periodicity.

In some other embodiments, the configuration includes a second indication preventing the network node 16 from transmitting any reference signal 106 of the one or more reference signals 106 during the inactive period 104.

In some embodiments, the configuration includes a third indication indicating a time location for at least one of the one or more reference signals 106. The time location is based on a wakeup period of the WD 22.

In some other embodiments, the time location is within a time window 110, and the time window 110 has at least one portion that overlaps with the wakeup period of the WD 22.

In some embodiments, the time location within the time window 110 is prior in time to the wakeup period of the WD 22.

In some other embodiments, the method further includes transmitting at least one of the one or more reference signals 106 at a time that corresponds to the time location.

In some embodiments, the at least one of the one or more reference signals 106 is usable by the WD 22 to perform a corresponding action before the wakeup period begins and before the WD 22 one or both of receives and transmits data during the wakeup period.

In some other embodiments, the configuration further includes a fourth indication indicating that if a wakeup signal is to be transmitted to the WD 22. The wakeup signal includes a notification of an upcoming on duration period within the active period 102 and a reference signal 106 available for the WD 22 associated with upcoming data.

In some embodiments, one or both of: (A) the configuration further includes a condition that if signaling is received from the WD 22, the received signal is to trigger the network node 16 to transmit at least one of the one or more reference signals 106; and (B) the method further includes receiving the signaling from the WD 22 and in response to receiving the signaling, transmitting the at least one of the one or more reference signals 106 to the WD 22.

In some other embodiments, the method further includes transmitting the configuration to the WD 22.

In some embodiments, the one or more reference signals 106 include one or both of a channel state information reference signal (CSI-RS), and a tracking reference signal (TRS).

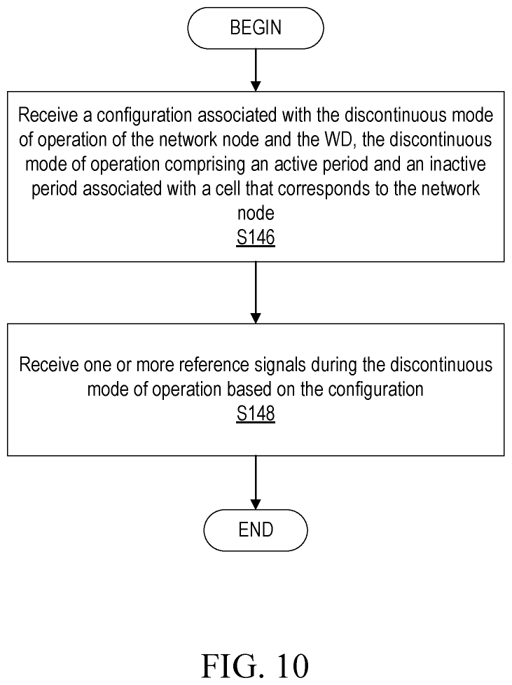

FIG. 10 is a flowchart of an exemplary process in a WD 22. One or more blocks described herein may be performed by one or more elements of WD 22 such as by one or more of processing circuitry 84 (including the WD management unit 34), processor 86, radio interface 82 and/or communication interface 60. WD 22 such as via processing circuitry 84 and/or processor 86 and/or radio interface 82 is configured to communicate with a network node 16 that is configured to manage reference signal transmissions during a discontinuous mode of operation. WD 22 is configured to receive (Block S146) a configuration associated with the discontinuous mode of operation of the network node 16 and the WD 22, where the discontinuous mode of operation includes an active period 102 and an inactive period 104 associated with a cell 18 that corresponds to the network node 16. WD 22 is also configured to receive (Block S148) one or more reference signals 106 during the discontinuous mode of operation based on the configuration.

In some embodiments, one or both of: (A) the configuration includes a first indication indicating that at least one reference signal 106 of the one or more reference signals 106 that is to be transmitted during the active period 102 has a first periodicity and at least one other reference signal 106 of the one or more reference signals 106 that is to be transmitted during the inactive period 104 has a second periodicity, where the second periodicity is lower than the first periodicity; and (B) the method further includes receiving the at least one reference signal 106 with the first periodicity and the at least one other reference signal 106 with the second periodicity.

In some other embodiments, the configuration includes a second indication preventing the network node 16 from transmitting any reference signal 106 of the one or more reference signals 106 during the inactive period 104.

In some embodiments, one or more of: (A) the configuration includes a third indication indicating a time location for at least one of the one or more reference signals 106, where the time location is based on a wakeup period of the WD 22; (B) the time location is within a time window 110, where the time window 110 has at least one portion that overlaps with the wakeup period of the WD 22; (C) the time location within the time window 110 is prior in time to the wakeup period of the WD 22; and (D) the method further includes transmitting at least one of the one or more reference signals 106 at a time that corresponds to the time location.

In some other embodiments, the at least one of the one or more reference signals 106 is usable by the WD 22 to perform a corresponding action before the wakeup period begins and before the WD 22 one or both of receives and transmits data during the wakeup period.

In some embodiments, the configuration further includes a fourth indication indicating that if a wakeup signal is to be transmitted to the WD 22, and the wakeup signal includes a notification of an upcoming on duration period within the active period 102 and a reference signal 106 available for the WD 22 associated with upcoming data.

Having described the general process flow of arrangements of the disclosure and having provided examples of hardware and software arrangements for implementing the processes and functions of the disclosure, the sections below provide details and examples of arrangements for handling periodic reference signal transmissions under cell discontinuous mode of operation. Reference signal (RS) as described herein may refer to any reference signals such as CSI-RS, TRS, etc. Discontinuous mode of operation may refer to DTX/DRX and may have an active period and an inactive period.

In some embodiments, a Cell DTX/DRX OFF period may be referred to as non-active period for a cell 18. In some other embodiments, a Cell DTX/DRX ON period may be referred to as active period for a cell 18. In some embodiments, an inactive period/time of Cell DTX/DRX may be referred to as non-active period/time for a cell 18 operating with cell DTX/DRX functionality. In some other embodiments, an active period/time of Cell DTX/DRX may be referred to as active period for a cell 18 operating with cell DTX/DRX functionality. However, the embodiments are not limited as such, and an active period may include other periods where WD 22 and/or network node 16 communicate or are configured to communicate with each other. Active period may also refer to any active period associated with a discontinuous mode of operation. An inactive period may also be any inactive period of a discontinuous mode of operation, e.g., where transmission of signals is reduced when compared to the active time.

In one or more embodiments below, CSI-RS for tracking or TRS may be the reference signal (RS) transmitted during a discontinuous mode of operation. In some embodiments, one or more steps may be performed for the case of periodic CSI-RS. In some other embodiments, it may be assumed that the WD 22 has received a configuration of cell DTX/DRX, e.g., through higher layer signaling. In some embodiments, the WD 22 may have also received a configuration of WD connected discontinuous reception (C-DRX).

In some embodiments, the WD 22 receives a first scheduling during the inactive time of cell DTX/DRX, e.g., a first scheduling PDCCH. As a result, additionally, the WD 22 receives a TRS, e.g., in one or more symbols after the first scheduling PDCCH. Further, the WD 22 may receive a first PDSCH. In on example, the WD 22 does not expect to receive extra TRSs for the following M scheduling occasions or based on a timer. In one nonlimiting example, the first scheduling PDCCH is always a cross-slot scheduling one. However, the first scheduling PDCCH is not limited as such and may be a cross-slot scheduling channel at times or not a cross-slot scheduling channel.

In some other embodiments, the WD 22 receives a configuration of potential TRS transmissions for the inactive time of cell DTX/DRX, e.g., every 20 ms. The configuration can additionally include a window of a specific length and periodicity within which the WD 22 can expect a TRS transmission. The WD 22 monitors TRS during a first TRS occasion or window, if a TRS is detected, then the WD 22 receives a first scheduling PDCCH and a first PDSCH. The configuration may additionally include a window of a specific length and periodicity within which the WD 22 can expect a TRS transmission.

In some embodiments, the WD 22 monitors TRS during a first TRS occasion or window, if a TRS is detected, then the WD 22 receives a first scheduling PDCCH and a first PDSCH.

In some other embodiments, the WD 22 may be configured with a C-DRX and an “onduration” timer, as such the TRS transmission window can be configured before the “onduration” timer, e.g., a window of specific length and periodicity and a specific offset to the “onduration” timer. In some embodiments, the TRS is assumed to be always transmitted in that window (e.g. even during inactive time of cell DTX/DRX). In some other embodiments, TRS is not assumed to be always transmitted, and if WD 22 does not detect a TRS transmission (e.g. in that window, e.g. during inactive time of cell DTX/DRX), the WD 22 does not expect to receive signaling such as a scheduling PDCCH which schedules a PDSCH during the “onduration” timer.

In some embodiments, the WD 22 may be configured with a wake up signal (WUS) before the on duration. The WD 22 receives a WUS indicating WD 22 to monitor other signaling such as PDCCH during the on-duration (e.g. or to start the on-duration timer), and based on the detected WD 22, the WD 22 may receive TRS either in a configured window (e.g. before start of and/or during the on-duration), or in the regular configured TRS occasions, i.e., the same TRS configuration as applicable to the active time of cell DTX/DRX.

In some other embodiments, the WD 22 receives a first TRS configuration for the active time of cell DTX/DRX, and a second TRS configuration for the inactive time of cell DTX/DRX. For example, the second configuration may have a longer periodicity than the first one. The WD 22 may be additionally configured with a third TRS configuration, when the cell DTX/DRX is deactivated, e.g., where the third configuration is the same as the first one.

In some embodiments, the WD 22 receives a TRS configuration, including at least a first periodicity and offset. During an active time of cell DTX/DRX, the WD 22 may assume that TRS is present in TRS occasions indicated by the TRS configuration according to the first periodicity and offset. During an inactive time of cell DTX/DRX, the WD 22 may assume that TRS is present in a subset of TRS occasions indicated by the TRS configuration according to the first periodicity and offset. The subset of TRS occasions may be indicated by at least one of a second periodicity, second offset, a decimation factor (e.g. a value of 4 may means TRS is present in only one (e.g. first or last) in four TRS occasions), a bitmap (e.g. indicating which TRS occasions include TRS transmissions such as a bit map of value 0010 may imply, every third TRS occasion contains TRS transmission, while the other TRS occasions may or may not contain TRS), etc.

In some other embodiments, NN 16 (e.g., an gNB) may configure Cell DTX. The WD 22 may be configured to/indicated that it does not need to monitor PDCCH in downlink (e.g. either at all, or very few occasions) during the time NN 16 is in Cell DTX inactive period.

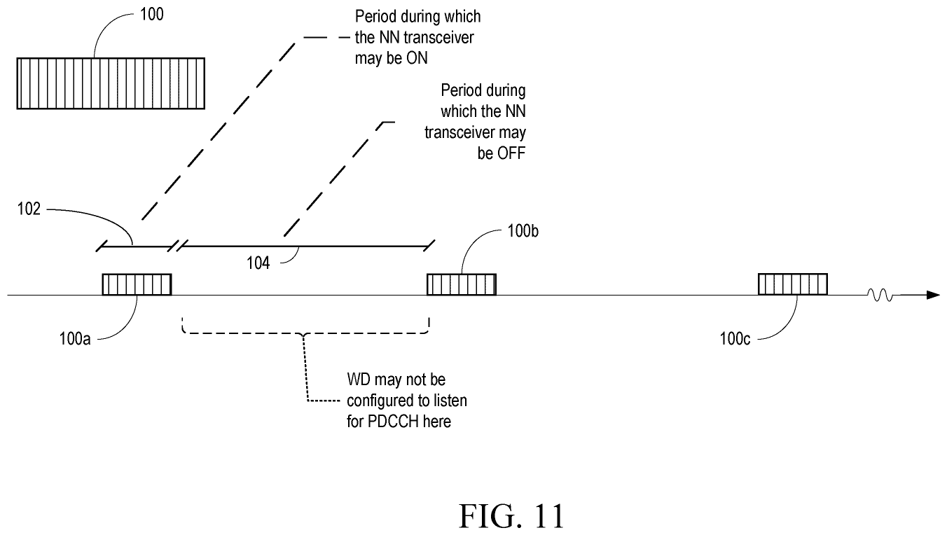

FIG. 11 shows example elements of communication between a network node according to some embodiments of the present disclosure. More specifically, signaling 100 may be transmitted or received by any component of system 10 such as WD 22 and/or NN 16. Signaling 100 may refer to transmission and/or reception of signaling during Cell DTX and Cell DRX, respectively. Signaling 100 may comprise one or more signals/signaling such as signaling 100a, 100b, 100c. Further, WD 22 and NN 16 may be configured with a discontinuous mode of operation having an active period 102 and an inactive period 104. The active period 102 may be Cell DTX/DRX active period. The inactive period 104 may be a Cell DTX/DRX inactive period. During active period 102, elements (such as transceivers) of communication interface 60 and/or radio interface 62 may be on. During inactive period 104, elements (such as transceivers) of communication interface 60 and/or radio interface 62 may be off.

In some embodiments, NN 16 may configure the WD 22 with a second set of C-DRX configuration that is applicable to inactive period 104, e.g., Cell DTX/DRX inactive period, but according to the second set, the WD 22 need not monitor PDCCH (e.g., the “onduration” of the second C-DRX configuration is 0, or any other configuration parameter, where the WD 22 needs not wakeup during the Cell DTX inactive period).

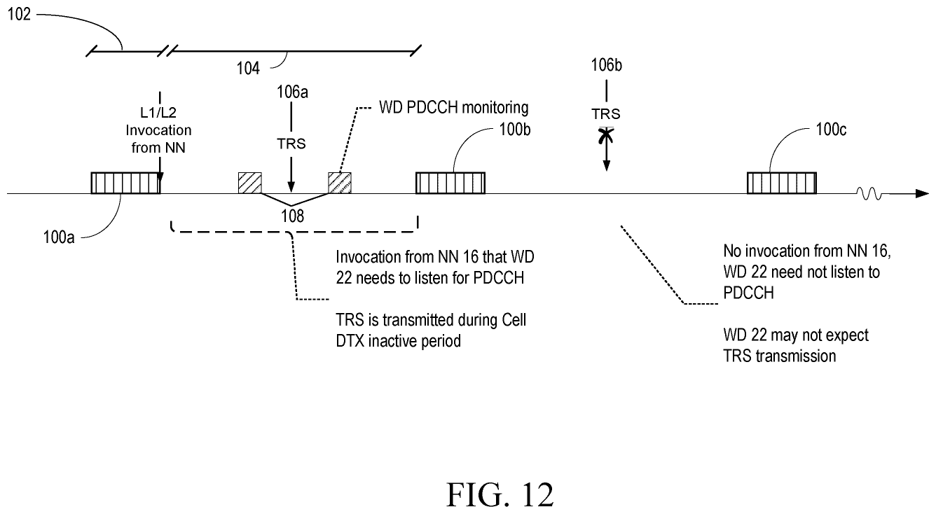

FIG. 12 shows example elements of communication between a network node 16 and a WD 22 at least during a discontinuous mode of operation. One or more reference signals 106 may be transmitted, such as reference signals 106a, 106b. There may be one or more occasions 108 where WD performs monitoring (e.g., PDCCH monitoring). NN 16 may be configured to perform a dynamic method for invoking the WD 22 per inactive period 104 (e.g., Cell DTX inactive period). For example, during inactive period 104 a reference signal 106a (e.g., TRS) may be transmitted, e.g., after NN 16 has transmitted and invocation to WD 22. If the WD 22 is not invoked, the WD 22 may not expect transmission of reference signal 106b (e.g., TRS). A WD 22 may receive dynamic signaling for invocation of Cell DTX inactive period, and if the WD 22 is not invoked, the WD 22 may not expect transmission of reference signal 106b.

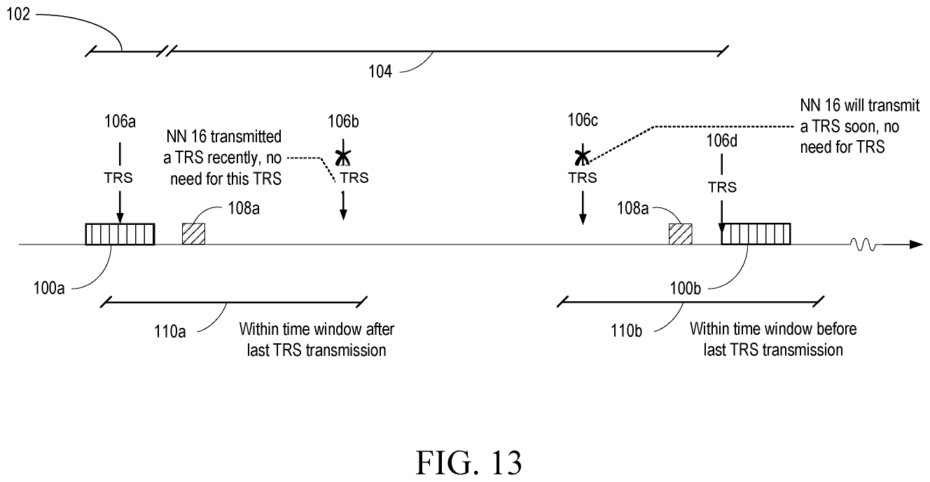

FIG. 13 shows other example elements of communication between a network node 16 and a WD 22 at least during a discontinuous mode of operation. Signaling 100a, 100b may be transmitted, e.g., during an active period 102. Reference signals 106 may or may not be transmitted during time windows 110a, 110b, which may have a portion that falls within the inactive period 104. NN 16 may configure/indicate the WD 22 to be active during inactive period 104 (Cell DTX/DRX inactive period) or invoke it dynamically. However, the occasions 108a, 108b of WD 22 activity may be within a certain time frame from recently transmitted or upcoming transmission of reference signals 106 (e.g., TRS). For example, the WD 22 may have recently had a TRS occasion or will soon have a TRS occasion and there is no need for extra transmissions in-between. The time window 110 of the present disclosure is not limited to the time window 110 of FIG. 13 and may be any other time window, e.g., with respect to any other transmission, active period 102, inactive period 104, signaling 100, wakeup period, etc.

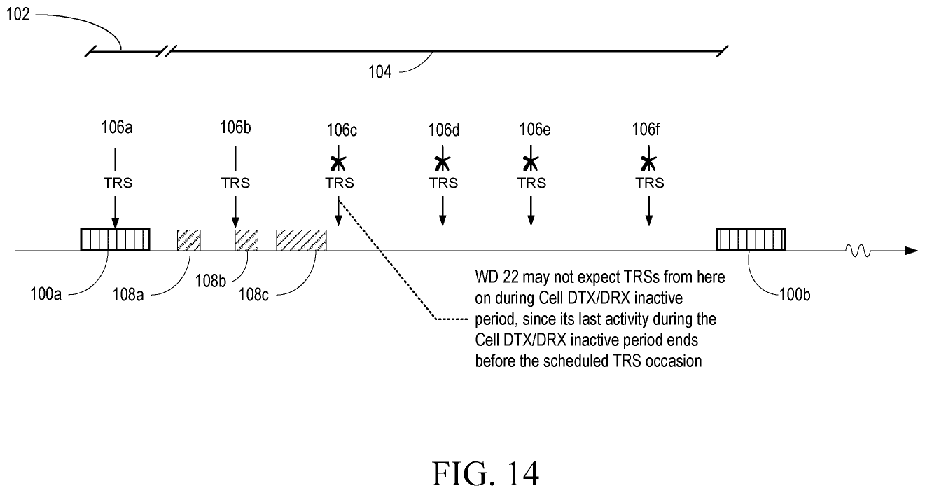

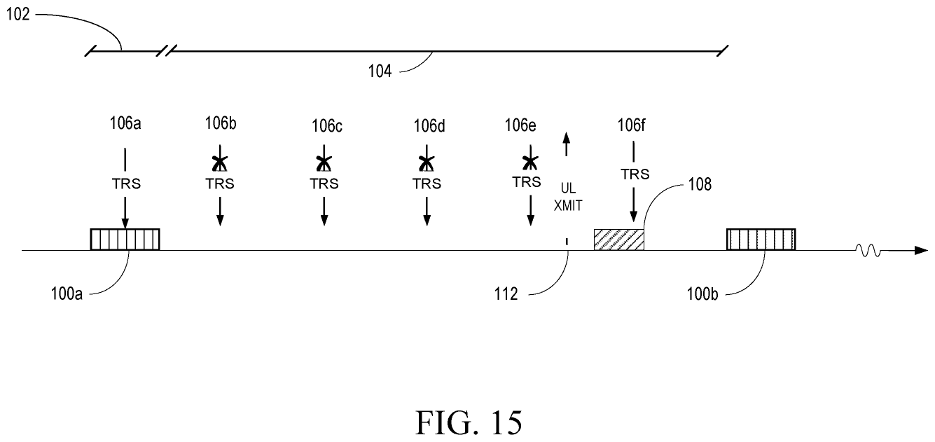

FIG. 14 shows example elements of communication between a network node 16 and a WD 22 at least during a discontinuous mode of operation. NN 16 may configure the WD 22 to be active during inactive period 104 (e.g., Cell DTX/DRX inactive period) or invoked it dynamically. However, the occasions 108a, 108b, 108c of WD 22 activity end before the scheduled reference signals 106b, 106d, 106e, 106f (e.g., TRS occasions). In other words, the reference signals 106b, 106d, 106e, 106f are dynamically turned off or not transmitted by NN 16 despite that they may have been configured to be periodically available or transmitted.

FIG. 15 shows example elements of communication between a network node 16 and a WD 22 at least during a discontinuous mode of operation. In one embodiment, NN 16 may not transmit or WD 22 does not expect references signals 106 transmissions (i.e., reference signals 106b, 106c, 106d, 106e, 106f) during inactive periods 104 (e.g., Cell DTX/DRX inactive periods), unless there is an uplink transmission 112 from the WD 22 or there is a specific type of UL transmission 112 from the WD 22, e.g., PRACH, Scheduling Request (SR), or alike. That is, in this example, since uplink transmission 112 is performed, reference signal 106f is transmitted. The transmission of reference signal 106f in response to WD UL transmission 112 can be immediate or according to configured schedule. In another example, transmission of reference signal 106 may be scheduled and associated information may be explicitly indicated in control message such as a downlink or uplink DCI (e.g. in response to WD UL transmission).

In some embodiments, there is no RS transmission during the inactive period 104 (e.g., cell DTX/DRX inactive period), but there are two different RS transmissions according to two different configurations during the active period (e.g., cell DTX/DRX active period), RS configuration set 1 and RS configuration set 2. In RS configuration set 2, RS 106 is transmitted more densely/frequently compared to that from RS configuration set 1. There is no restriction on RS transmission according to configuration set 1. There may be some restriction on RS transmission according to configuration set 2. For example, RS transmission according to set 2 can only last for N times. Which RS configuration is used may depend on when WD 22 receives its last RS 106. A threshold is configured by NN 16 to WD 22. If the duration that WD 22 did not receive its last RS 106 is smaller than this threshold, RS configuration set 1 is used during the active period 102. If the duration that WD 22 did not receive its last RS 106 is larger than this threshold, RS configuration set 2 is used in the active period 102 and then followed by an RS configuration set 1.

In some other embodiments, there is no RS transmission in the inactive period 104, but there are two different RS transmissions according to two different configurations in the active period 104, RS configuration set 1 and RS configuration set 2. In RS configuration set 2, RS 106 is transmitted more densely/frequently compared to that from RS configuration set 1. There is no restriction on RS transmission according to configuration set 1. There is some restriction on RS transmission according to configuration set 2. For example, RS transmission according to set 2 may only last for N times. In the initial time of the active period (e.g., cell DTX/DRX active period), NN 16 requests WD 22 to feedback how RS 106 should be transmitted according to configuration set 1, or according to configuration set 2. If WD 22 request to transmit RS 106 according to configuration set 2, RS 106 will be transmitted according to configuration set 1 after RS 106 is transmitted according to set 2.

The following is a nonlimiting list of example embodiments.

Embodiment A1. A network node configured to communicate with a wireless device (WD), the network node configured to, and/or comprising a radio interface and/or comprising processing circuitry configured to:
determine a configuration associated with communication between the network node and the WD during a discontinuous mode of operation, the discontinuous mode of operation being associated with an inactive period associated with a cell; and
transmit signaling during the discontinuous mode of operation based on the configuration.

Embodiment A2. The network node of Embodiment A1, wherein the network node is configured to:
transmit a first scheduling physical downlink control channel (PDCCH) during the inactive period of the discontinuous mode of operation; and
transmit a tracking reference signal (TRS) after the first scheduling PDCCH and after the WD receives a first physical downlink shared channel (PDSCH).

Embodiment A3. The network node of any one of Embodiment A1 and A2, wherein one or more of:
the network node is configured to transmit the configuration to the WD, the configuration comprising an indication of potential TRS transmissions for the inactive period of cell discontinuous transmission and/or reception;
the configuration indicates a window of a specific length and periodicity within which the WD can expect a TRS transmission; and
the configuration triggers the WD to monitor TRS during a first TRS occasion or TRS window and/or to receive a first scheduling PDCCH and a first PDSCH if a TRS is detected.

Embodiment A4. The network node of any one of Embodiment A1-A3, wherein the network node is further configured to one or more of:
transmit a TRS configuration comprising at least a first periodicity and offset, the TRS configuration triggering the WD to, during an active time of cell discontinuous transmission and/or reception, assume that TRS is present in TRS occasions indicated by the TRS configuration according to the first periodicity and offset;
determine a cell discontinuous transmission configuration indicating that the WD does not need to monitor PDCCH in downlink during a time the network node is in a cell discontinuous transmission inactive period;
stop a TRS transmission or cause the WD to not expect the TRS transmission during cell discontinuous transmission and/or reception inactive periods, unless there is an uplink transmission from the WD or there is a predetermined type of uplink transmission from the WD; and
cause first and second TRS transmissions in a cell discontinuous transmission and/or reception active period according to first and second TRS configuration sets, respectively.

Embodiment B1. A method implemented in a network node configured to communicate with a wireless device (WD), the method comprising:
determining a configuration associated with communication between the network node and the WD during a discontinuous mode of operation, the discontinuous mode of operation being associated with an inactive period associated with a cell; and
transmitting signaling during the discontinuous mode of operation based on the configuration.

Embodiment B2. The method of Embodiment B1, wherein the method further comprises:
transmitting a first scheduling physical downlink control channel (PDCCH) during the inactive period of the discontinuous mode of operation; and
transmitting a tracking reference signal (TRS) after the first scheduling PDCCH and after the WD receives a first physical downlink shared channel (PDSCH).

Embodiment B3. The method of any one of Embodiment B1 and B2, wherein one or more of:
the method further comprises transmitting the configuration to the WD, the configuration comprising an indication of potential TRS transmissions for the inactive period of cell discontinuous transmission and/or reception;
the configuration indicates a window of a specific length and periodicity within which the WD can expect a TRS transmission; and
the configuration triggers the WD to monitor TRS during a first TRS occasion or TRS window and/or to receive a first scheduling PDCCH and a first PDSCH if a TRS is detected.

Embodiment B4. The method of any one of Embodiment B1-B3, wherein the method comprises one or more of:
transmitting a TRS configuration comprising at least a first periodicity and offset, the TRS configuration triggering the WD to, during an active time of cell discontinuous transmission and/or reception, assume that TRS is present in TRS occasions indicated by the TRS configuration according to the first periodicity and offset;
determining a cell discontinuous transmission configuration indicating that the WD does not need to monitor PDCCH in downlink during a time the network node is in a cell discontinuous transmission inactive period;
stopping a TRS transmission or cause the WD to not expect the TRS transmission during cell discontinuous transmission and/or reception inactive periods, unless there is an uplink transmission from the WD or there is a predetermined type of uplink transmission from the WD; and
causing first and second TRS transmissions in a cell discontinuous transmission and/or reception active period according to first and second TRS configuration sets, respectively.

Embodiment C1. A wireless device (WD) configured to communicate with a network node, the WD configured to, and/or comprising a radio interface and/or comprising processing circuitry configured to:
determine a configuration associated with communication between the network node and the WD during a discontinuous mode of operation, the discontinuous mode of operation being associated with an inactive period associated with a cell; and
receive signaling during the discontinuous mode of operation based on the configuration.

Embodiment C2. The WD of Embodiment C1, wherein the WD is configured to:
receive a first scheduling physical downlink control channel (PDCCH) during the inactive period of the discontinuous mode of operation; and
receive a tracking reference signal (TRS) after the first scheduling PDCCH and after the WD receives a first physical downlink shared channel (PDSCH).

Embodiment C3. The WD of any one of Embodiment C1 and C2, wherein one or more of:
the WD is configured to receive the configuration from the network node, the configuration comprising an indication of potential TRS transmissions for the inactive period of cell discontinuous transmission and/or reception;
the configuration indicates a window of a specific length and periodicity within which the WD can expect a TRS transmission; and
the configuration triggers the WD to monitor TRS during a first TRS occasion or TRS window and/or to receive a first scheduling PDCCH and a first PDSCH if a TRS is detected.

Embodiment C4. The WD of any one of Embodiment C1-C3, wherein the WD is further configured to one or more of:
receive a TRS configuration comprising at least a first periodicity and offset, the TRS configuration triggering the WD to, during an active time of cell discontinuous transmission and/or reception, assume that TRS is present in TRS occasions indicated by the TRS configuration according to the first periodicity and offset;
determine a cell discontinuous transmission configuration indicating that the WD does not need to monitor PDCCH in downlink during a time the network node is in a cell discontinuous transmission inactive period;
determine that the TRS transmission is not expected during cell discontinuous transmission and/or reception inactive periods, unless there is an uplink transmission from the WD or there is a predetermined type of uplink transmission from the WD; and
receive first and second TRS transmissions in a cell discontinuous transmission and/or reception active period according to first and second TRS configuration sets, respectively.

Embodiment D1. A method in a wireless device (WD) configured to communicate with a network node, the method comprising:
determining a configuration associated with communication between the network node and the WD during a discontinuous mode of operation, the discontinuous mode of operation being associated with an inactive period associated with a cell; and
receiving signaling during the discontinuous mode of operation based on the configuration.

Embodiment D2. The method of Embodiment D1, wherein the method further comprises:
receiving a first scheduling physical downlink control channel (PDCCH) during the inactive period of the discontinuous mode of operation; and
receiving a tracking reference signal (TRS) after the first scheduling PDCCH and after the WD receives a first physical downlink shared channel (PDSCH).

Embodiment D3. The method of any one of Embodiment D1 and D2, wherein one or more of:
the method further comprises receiving the configuration from the network node, the configuration comprising an indication of potential TRS transmissions for the inactive period of cell discontinuous transmission and/or reception;
the configuration indicates a window of a specific length and periodicity within which the WD can expect a TRS transmission; and
the configuration triggers the WD to monitor TRS during a first TRS occasion or TRS window and/or to receive a first scheduling PDCCH and a first PDSCH if a TRS is detected.

Embodiment D4. The method of any one of Embodiment D1-D3, wherein the method further comprises one or more of:
receiving a TRS configuration comprising at least a first periodicity and offset, the TRS configuration triggering the WD to, during an active time of cell discontinuous transmission and/or reception, assume that TRS is present in TRS occasions indicated by the TRS configuration according to the first periodicity and offset;
determining a cell discontinuous transmission configuration indicating that the WD does not need to monitor PDCCH in downlink during a time the network node is in a cell discontinuous transmission inactive period;
determining that the TRS transmission is not expected during cell discontinuous transmission and/or reception inactive periods, unless there is an uplink transmission from the WD or there is a predetermined type of uplink transmission from the WD; and
receiving first and second TRS transmissions in a cell discontinuous transmission and/or reception active period according to first and second TRS configuration sets, respectively.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
CSI-RS Channel State Information-Reference Signal
DCI Downlink Control Information
NW Network
PEI Paging Early Indicator
PO Paging Occasion
SI System Information
SIB System Information Block
SSS Secondary Synchronization Signal
TRS Tracking Reference Signal or CSI-RS for tracking
TRSA TRS Availability
UE User Equipment

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a wireless device, WD, and to manage reference signal transmissions during a discontinuous mode of operation, the method comprising:
determining a configuration associated with the discontinuous mode of operation of the network node and the WD, the discontinuous mode of operation comprising an active period and an inactive period associated with a cell that corresponds to the network node; and
transmitting one or more reference signals during the discontinuous mode of operation based on the configuration.

2. The method of claim 1, wherein one or both of:
the configuration includes a first indication indicating that at least one reference signal of the one or more reference signals that is to be transmitted during the active period has a first periodicity and at least one other reference signal of the one or more reference signals that is to be transmitted during the inactive period has a second periodicity, the second periodicity being lower than the first periodicity; and
the method further includes transmitting the at least one reference signal with the first periodicity and the at least one other reference signal with the second periodicity.

3. The method of claim 1, wherein the configuration includes a second indication preventing the network node from transmitting any reference signal of the one or more reference signals during the inactive period.

4. The method of claim 1, wherein the configuration includes a third indication indicating a time location for at least one of the one or more reference signals, the time location being based on a wakeup period of the WD.

5. The method of claim 4, wherein the time location is within a time window, the time window having at least one portion that overlaps with the wakeup period of the WD.

6. The method of claim 5, wherein the time location within the time window is prior in time to the wakeup period of the WD.

7. The method of claim 4, wherein the method further includes:
transmitting at least one of the one or more reference signals at a time that corresponds to the time location.

8. The method of claim 7, wherein the at least one of the one or more reference signals is usable by the WD to perform a corresponding action before the wakeup period begins and before the WD one or both of receives and transmits data during the wakeup period.

9. The method of claim 1, wherein the configuration further includes a fourth indication indicating that if a wakeup signal is to be transmitted to the WD, the wakeup signal includes a notification of an upcoming on duration period within the active period and a reference signal available for the WD associated with upcoming data.

10. The method of claim 1, wherein one or both of:
the configuration further includes a condition that if signaling is received from the WD, the received signal is to trigger the network node to transmit at least one of the one or more reference signals; and
the method further includes receiving the signaling from the WD and in response to receiving the signaling, transmitting the at least one of the one or more reference signals to the WD.

11. The method of claim 1, wherein the method further includes:
transmitting the configuration to the WD.

12. The method of claim 1, wherein the one or more reference signals include one or both of a channel state information reference signal, CSI-RS, and a tracking reference signal, TRS.

13. A network node configured to communicate with a wireless device, WD, and to manage reference signal transmissions during a discontinuous mode of operation, the network node being configured to:
determine a configuration associated with the discontinuous mode of operation of the network node and the WD, the discontinuous mode of operation comprising an active period and an inactive period associated with a cell that corresponds to the network node; and
transmit one or more reference signals during the discontinuous mode of operation based on the configuration.

14. The network node of claim 13, wherein one or both of:
the configuration includes a first indication indicating that at least one reference signal of the one or more reference signals that is to be transmitted during the active period has a first periodicity and at least one other reference signal of the one or more reference signals that is to be transmitted during the inactive period has a second periodicity, the second periodicity being lower than the first periodicity; and
the network node is further configured to transmit the at least one reference signal with the first periodicity and the at least one other reference signal with the second periodicity.

15. The network node of claim 13, wherein the configuration includes a second indication preventing the network node from transmitting any reference signal of the one or more reference signals during the inactive period.

16. The network node of claim 13, wherein the configuration includes a third indication indicating a time location for at least one of the one or more reference signals, the time location being based on a wakeup period of the WD.

17. The network node of claim 16, wherein the time location is within a time window, the time window having at least one portion that overlaps with the wakeup period of the WD.

18. The network node of claim 17, wherein the time location within the time window is prior in time to the wakeup period of the WD.

19.-24. (canceled)

25. A method in a wireless device, WD, configured to communicate with a network node configured to manage reference signal transmissions during a discontinuous mode of operation, the method comprising:
receiving a configuration associated with the discontinuous mode of operation of the network node and the WD, the discontinuous mode of operation comprising an active period and an inactive period associated with a cell that corresponds to the network node; and
receiving one or more reference signals during the discontinuous mode of operation based on the configuration.

26.-30. (canceled)

31. A wireless device, WD, configured to communicate with a network node configured to manage reference signal transmissions during a discontinuous mode of operation, the WD being configured to:
receive a configuration associated with the discontinuous mode of operation of the network node and the WD, the discontinuous mode of operation comprising an active period and an inactive period associated with a cell that corresponds to the network node; and
receive one or more reference signals during the discontinuous mode of operation based on the configuration.

32.-36. (canceled)
